(19) United States
(12) Patent Application Publication
(10) Pub. No.: US 2005/0186492 A1
(43) Pub. Date: Aug. 25, 2005

(54) Electrophotographic photoreceptor and electrophotographic imaging apparatus using the same

(75) Inventors: Saburo Yokota, Suwon-si (KR); Hwan-koo Lee, Suwon-si (KR); Beom-jun Kim, Seongnam-si (KR); Seung-ju Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/045,183

(22) Filed: Jan. 31, 2005

(30) Foreign Application Priority Data
Feb. 11, 2004 (KR) 10-2004-8928

(51) Int. Cl. G03G 5/14

(52) U.S. Cl. 430/60; 399/159

(57) ABSTRACT

An electrophotographic photoreceptor includes an electrically conductive substrate including a resin; an intermediate layer formed on the electrically conductive substrate; and a photosensitive layer formed on the intermediate layer. In the electrophotographic photoreceptor, the intermediate layer includes an alcohol soluble polyamide and an alcohol soluble chelate compound. The electrophotographic photoreceptor has effective electrical and mechanical properties and may very productively be mass-produced.

### CROSS-REFERENCE TO RELATED APPLICATIONS

This application claims the benefit of Korean Patent Application No. 10-2004-0008928, filed on Feb. 11, 2004, in the Korean Intellectual Property Office, the disclosure of which is incorporated herein in its entirety by reference.

### BACKGROUND OF THE INVENTION

1. Field of the Invention

The present invention relates to an electrophotographic photoreceptor having a resinous substrate and a specific intermediate layer and an electrophotographic imaging apparatus using the same, and more particularly, to an effective electrophotographic photoreceptor having optimized mechanical and electrical properties and an electrophotographic imaging apparatus using the same.

2. Description of the Related Art

Electrophotographic photoreceptors used for electrophotographic imaging apparatuses such as photocopiers, printers, and facsimiles and the like, generally include a photosensitive layer containing a charge generating material, and a charge transport material and the like, on an electrically conductive substrate. Also, the electrophotographic photoreceptors may further include a functional layer, such as an intermediate layer, or a surface protective layer in addition to the photosensitive layer.

The electrically conductive substrate is mainly composed of aluminum or an alloy thereof. Recently, to reduce costs, an electrically conductive substrate containing a resin as a main component was actively investigated as disclosed in U.S. Pat. No. 6,221,547. The resinous substrate was generally formed by dispersing an electrically conductive material such as electroconductive carbon in a resin such as polyester, polycarbonate, polyamide, or polyimide or the like. The electrically conductive material forms an ohmic junction with the electron generating material in the photosensitive layer, which allows a charge to be readily injected. As a result, a charging property of the photoreceptor deteriorates.

Thus, an intermediate layer capable of effectively acting as a charge barrier is required. The intermediate layer is generally formed by dispersing an inorganic/organic filler, and the like in a binder resin. Various polymer materials may be used for the binder resin, but polyamide resin is generally used due to its effective solvent-resistance, electrical and mechanical properties.

However, the polyamide resin typically has poor compatibility with other resins and high hydrophilicity, and thus, has poor adhesiveness to the resinous substrate or the photosensitive layer. Also, its electrical property tends to be affected by humidity.

### SUMMARY OF THE INVENTION

The present invention provides an electrophotographic photoreceptor using a resinous substrate, thus having optimized mechanical and electrical properties of an intermediate layer containing an alcohol soluble polyamide as a binder resin.

The present invention also provides an electrophotographic imaging apparatus, an electrophotographic cartridge, and an electrophotographic drum using the electrophotographic photoreceptor.

According to an aspect of the present invention, an electrophotographic photoreceptor includes: an electrically conductive substrate including a resin as a main component; an intermediate layer formed on the electrically conductive substrate; and a photosensitive layer formed on the intermediate layer, wherein the intermediate layer includes an alcohol soluble polyamide and an alcohol soluble chelate compound.

According to another aspect of the present invention, an electrophotographic imaging apparatus includes an electrophotographic photoreceptor, wherein the electrophotographic photoreceptor includes an electrically conductive substrate including a resin as a main component, an intermediate layer formed on the electrically conductive substrate; and a photosensitive layer formed on the intermediate layer, the intermediate layer including an alcohol soluble polyamide and an alcohol soluble chelate compound.

According to another aspect of the present invention, an electrophotographic cartridge includes: an electrophotographic photoreceptor including an electrically conductive substrate including a resin as a main component, an intermediate layer formed on the electrically conductive substrate, and a photosensitive layer formed on the intermediate layer, the intermediate layer including an alcohol soluble polyamide and an alcohol soluble chelate compound; and at least one of a charging device charging the electrophotographic photoreceptor, a developing device developing an electrostatic latent image formed on the electrophotographic photoreceptor, and a cleaning device cleaning a surface of the electrophotographic photoreceptor, wherein the electrophotographic cartridge is attachable to or detachable from an image forming apparatus.

According to another aspect of the present invention, an electrophotographic drum includes: a drum that is attachable to or detachable from an image forming apparatus; and an electrophotographic photoreceptor disposed on the drum, wherein the electrophotographic photoreceptor includes an electrically conductive substrate including a resin as a main component, an intermediate layer formed on the electrically conductive substrate, and a photosensitive layer formed on the intermediate layer, the intermediate layer including an alcohol soluble polyamide and an alcohol soluble chelate compound.

According to another aspect of the present invention, an image forming apparatus includes: a photoreceptor unit including an electrically conductive substrate including a resin as a main component, an intermediate layer formed on the electrically conductive substrate, and a photosensitive layer formed on the intermediate layer, the intermediate layer including an alcohol soluble polyamide and an alcohol soluble chelate compound; a charging device charging the photoreceptor unit; an imagewise light irradiating device irradiating imagewise light onto the charged photoreceptor unit to form an electrostatic latent image on the photoreceptor unit; a developing unit developing the electrostatic latent image with a toner to form a toner image on the photoreceptor unit; and a transfer device transferring the toner image onto a receiving medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view of an electrophotographic photoreceptor including a single-layered type photosensitive layer according to an embodiment of the present invention;

FIG. 2 is a schematic cross-sectional view of an electrophotographic photoreceptor including a laminated type photosensitive layer according to another embodiment of the present invention;

FIG. 3 is a schematic cross-sectional view of an electrophotographic photoreceptor including a laminated type photosensitive layer according to another embodiment of the present invention; and

FIG. 4 is a schematic view of an electrophotographic imaging apparatus, an electrophotographic drum and an electrophotographic cartridge including an electrophotographic photoreceptor according to embodiments of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

In general, a coating of polyamide resin has poor adhesiveness to polycarbonate resin or polyester resin. However, an intermediate layer of the present invention has optimizes adhesiveness by using a polyamide resin together with a chelate compound. Also, in general, a barrier property of an intermediate layer of polyamide resin tends to be lowered by moisture absorption. Particularly, when using a resinous substrate, injection of a charge often occurs due to an electrically conductive material of the substrate operating under high temperature and humidity, thus significantly lowering the charging property of a photoreceptor.

However, according to embodiments of the present invention, the charging property of the electrophotographic photoreceptor may be greatly improved by using a polyamide resin together with the chelate compound in the intermediate layer. It is assumed that this improvement of performances is due to control of a moisture adsorption of the polyamide by a crosslinking function of the chelate compound.

Since the coating solution for the intermediate layer using an alcohol soluble chelate compound almost never undergoes a crosslinking reaction at room temperature, unlike the case in which another crosslinker is used, the storage stability of the electrophotographic photoreceptor of the present invention is very effective. Since the coating may be readily applied by the dip coating method, which is generally used for mass production, an electrophotographic photoreceptor of the present invention may very efficiently be mass-produced. Also, the intermediate layer of the electrophotographic photoreceptor according to embodiments of the present invention may further contain a polyvinylacetal resin, thus improving adhesiveness of the intermediate layer to the resinous electrically conductive substrate and dispersion stability of a filler.

The electrophotographic photoreceptor and an electrophotographic imaging apparatus using the same according to embodiments of the present invention will now be described in more detail.

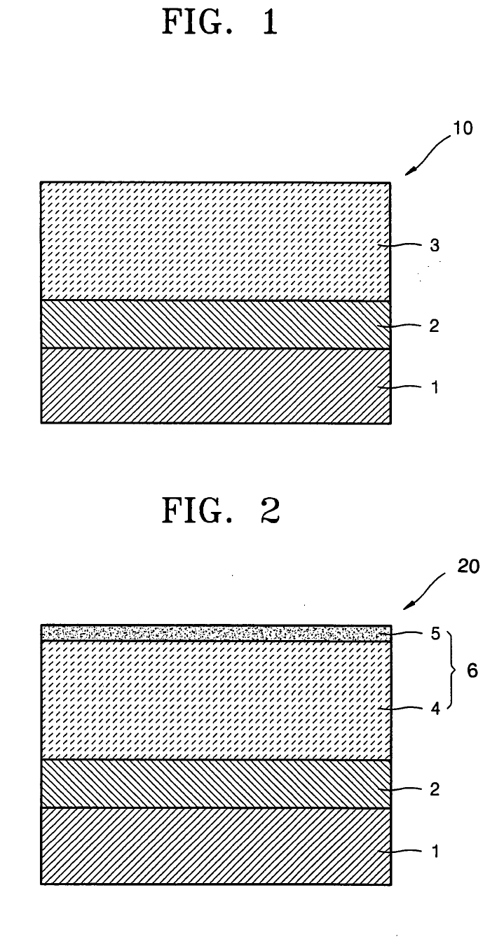

FIGS. 1 through 3 illustrate the electrophotographic photoreceptors according to embodiments of the present invention.

Referring to FIG. 1, a photoreceptor 10 according to an embodiment of the present invention includes a resinous electrically conductive substrate 1, an intermediate layer 2 according to an embodiment of the present invention formed on the substrate, and a single-layered type photosensitive layer 3 formed on the intermediate layer.

Referring to FIG. 2, a photoreceptor 20 according to another embodiment of the present invention includes a resinous electrically conductive substrate 1, an intermediate layer 2 according to an embodiment of the present invention formed on the substrate, and a laminated type photosensitive layer 6 formed on the intermediate layer, the photosensitive layer 3 sequentially including a charge transport layer 4 and a charge generating layer 5.

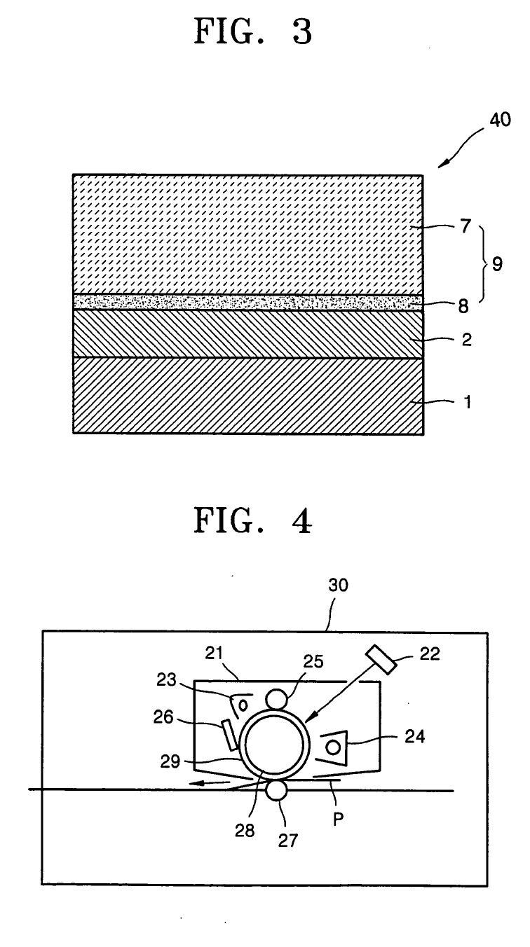

Referring to FIG. 3, a photoreceptor 40 according to another embodiment of the present invention includes a resinous electrically conductive substrate 1, an intermediate layer 2 according to an embodiment of the present invention formed on the substrate, and a laminated type photosensitive layer 9 formed on the intermediate layer, the photosensitive layer 9 sequentially including a charge generating layer 8 and a charge transport layer 7.

The photoreceptor according to any one of FIGS. 1 through 3 may further include a protective layer (not shown) thereon.

FIG. 4 is a schematic view of an image forming apparatus 30 including an electrophotographic drum 28 and an electrophotographic cartridge 21, according to the present invention. The electrophotographic cartridge 21 typically includes an electrophotographic photoreceptor 29, one or more charging devices 25 charging the electrophotographic photoreceptor 29, a developing device 24 developing an electrostatic latent image formed on the electrophotographic photoreceptor 29, and a cleaning device 26 cleaning a surface of the electrophotographic photoreceptor 29. The electrophotographic cartridge 21 can be attached to and detached from the image forming apparatus 30. The electrophotographic photoreceptor 29 has any one of the structures illustrated in FIGS. 1 through 3.

The electrophotographic photoreceptor drum 28, 29 of image forming apparatus 30 may generally be attached to and detached from the image forming apparatus 30 and includes the drum 28 on which the electrophotographic photoreceptor 29 is disposed.

Generally, the image forming apparatus 30 includes a photoreceptor unit (for example, the drum 28 and the electrophotographic photoreceptor 29); the charging device 25 charging the photoreceptor unit; an imagewise light irradiating device 22 irradiating light onto the charged photoreceptor unit to form an electrostatic latent image on the photoreceptor unit; the developing unit 24 developing the electrostatic latent image with a toner to form a toner image on the photoreceptor unit; and a transfer device 27 transferring the toner image onto a receiving medium, such as paper Pm and the photoreceptor unit includes the electrophotographic photoreceptor 29 as described above. The charging device 25 may be supplied with a voltage as a charging unit and may contact and charge the electrophotographic photoreceptor 29. The image forming apparatus 30 may also include a pre-exposure unit 23 to erase residual charge on the surface of the electrophotographic photoreceptor 29 to prepare for a next cycle.

The electrophotographic photoreceptor according to embodiments of the present invention used for the electrophotographic imaging apparatus, and the like will now be described in more detail.

A substrate containing a resin as a main component and having a drum or a belt shape may be used as the electrically conductive substrate. Examples of the resin used for the electrically conductive substrate include polyester resin, polycarbonate resin, polyamide resin, polyimide resin, and a copolymer of monomers used for synthesis of these resins. These resins are generally electrically insulating materials, and thus, are required to be treated to become electrically conductive. The treating method includes a method of dispersing an electrically conductive material, such as electroconductive carbon, tin oxide, and indium oxide in the resin.

In the electrophotographic photoreceptor according to an embodiment of the present invention, the intermediate layer formed on the electrically conductive substrate contains an alcohol soluble polyamide resin as a binder resin. Examples of the alcohol soluble polyamide include, but are not limited to, nylons 6, 7, 8, 11, 12, 66, 610, and 612. Specific examples of the polyamide resin include, but are not limited to, “AMILAN” (trade name) available from TORAY, “DIAMID” and “VESTAMID” (trade names) available from DAICEL-DEGUSSA, “ULTRAMID” (trade name) available from BASF, and “TORESIN” (trade name) available from NAGASE CHEMTEX.

In the electrophotographic photoreceptor, the intermediate layer is formed from a coating solution containing the alcohol soluble chelate compound as well as the alcohol soluble polyamide resin. The alcohol soluble chelate compound generally has effective affinity to polyamide resin, and thus, may optimize adhesiveness of the intermediate layer to the substrate or photosensitive layer. Also, the chelate compound may react with a hydroxyl group, an amino group, an amide group, a carboxyl group, and the like under a specific condition and crosslink the polyamide chains, thus optimizing strength, moisture resistance, and the like of the polyamide resin. However, unlike general crosslinkers, the chelate compound has a very low crosslinking reactivity under typical storage conditions. Thus, the chelate compound has effective solution stability and is readily utilized by a dip coating method, which is effective for mass production. Also, the polyamide resin bonded with the chelate compound has effective electroconductivity, and thus, may prevent deterioration in an electrostatic property due to accumulation of charge by controlling a compounding ratio of the chelate compounds to the polyamide resin instead of using other electroconductive fillers and/or charge transporting fillers.

The alcohol soluble chelate compound used in embodiments of the present invention includes various chelate compounds, which may be acetylacetonate chelate compounds, acetoacetate chelate compounds, lactate chelate compounds, glycolate chelate compounds, and the like.

The chelate compound used in the present invention may be a compound having a titanium atom or a zirconium atom as a core metal. Examples of the titanium based chelate compound include, are not limited to, TYZOR AA, DC, and LA (all available from DUPONT), and ORGATICS TC (available from MATSUMOTO CHEMICAL INDUSTRY CO., LTD.). Examples of the zirconium based chelate compound include, but are not limited to, ORGATICS ZC (available from MATSUMOTO CHEMICAL INDUSTRY CO., LTD.). Also, these compounds may be used in a combination of two or more. An amount of the chelate compound added may be in a range of 1-100 parts by weight based on 100 parts by weight of the polyamide resin.

The intermediate layer of the present invention may also contain polyvinylacetal resin, thus greatly improving the adhesiveness of the intermediate layer to the substrate or the photosensitive layer or dispersion stability of a filler. The polyvinylacetal resin may be typically obtained by acetalizing polyvinylalcohol resin. There are various types of polyvinylacetal resin depending upon a degree of acetalization and a degree of polymerization. The type of usable polyvinylacetal resin is not particularly restricted, but polyvinylacetal resins having a degree of acetalization of 65% or less may be used in terms of compatibility with polyamide resin. Such polyvinylacetal resins include polyvinylbutyral and polyvinylformal. Examples of the polyvinylacetal resin include, but are not limited to, S-LEC BM-1, BM-5, BH-3, BL-1, BL-2, and BX-L (trade names) available form SEKISUI CHEMICAL. The amount of the polyvinylacetal resin may be in a range of 1-10% by weight of total weight of the binder resin in the intermediate layer.

The intermediate layer of embodiments of the present invention may further contain a charge transport material or a filler of an inorganic or organic compound to improve its electrical, optical, and mechanical properties. In the case of adding the charge transport material, any one of a hole transporting material or an electron transporting material may be selected as needed. But, those materials having an alcohol solubility may preferably be used in terms of solubility and compatibility with the resin. Examples of the filler include fine powders of titanium oxide, silica, aluminum oxide, and tin oxide, or organic pigments.

The formation of the intermediate layer is achieved, for example, by dissolving and dispersing an alcohol soluble polyamide, a chelate compound, and, if necessary, a charge transport material, a filler, and the like, in a solvent to obtain an coating solution, uniformly coating the coating solution on an electrically conductive substrate, preferably through a dip coating method, and drying and hardening the coating by heating. The coating may be heated typically at a temperature of 90-200° C. for approximately 5-60 minutes. Although a dip coating method may be used for coating the coating solution, a ring coating method, a roll coating method, a spray coating method, and the like may also be used.

The thickness of the intermediate layer may be typically set in a range of 0.1-10 μm, and may be in a range of 0.5-6 μm.

If the thickness of the intermediate layer is lower than 0.1 μm, the intermediate layer may be an ineffective charge barrier. If the thickness is greater than 10 μm, the electrical performances tend to deteriorate due to the increase of layer resistance preventing the rapid carrier transport from the photosensitive layer to the substrate.

The photosensitive layer formed on the intermediate layer may be a laminated type wherein a charge generating layer and a charge transport layer are separately formed, or a single-layered type wherein one layer performs both a charge generating function and a charge transport function.

Examples of the charge generating material used in the photosensitive layer include organic materials such as phthalocyanine pigments, azo pigments, quinone pigments, perylene pigments, indigo pigments, bisbenzoimidazole pigments, quinacridone pigments, azulenium dyes, squarylium dyes, pyrylium dyes, triarylmethane dyes, and cyanine dyes, and inorganic materials such as amorphous silicon, amorphous selenium, trigonal selenium, tellurium, selenium-tellurium alloy, cadmium sulfide, antimony sulfide, and zinc sulfide. The charge generating materials used in the photosensitive layer are not limited to the materials listed herein, and may be used alone or in a combination of two or more.

In the case of the laminated type photoreceptor, the charge generating layer is formed by dispersing the charge generating material together with a binder resin in a solvent and applying the resulting dispersion to the intermediate layer or by forming a film through vacuum deposition, sputtering, a CVD method, or the like. The thickness of the charge generating layer may be typically set in a range of 0.1-1 μm. If the thickness is lower than 0.1 μm, the sensitivity of the photoreceptor is insufficient, and if the thickness is greater than 1 μm, the charging ability and sensitivity of the photoreceptor are lowered.

In the case of the single-layered type photoreceptor, the photosensitive layer may be obtained by dispersing the charge generating material together with a binder resin, a charge transport material, and the like, in a solvent and applying the resulting solution to the intermediate layer.

Examples of the solvent used for coating include organic solvents such as alcohols, ketones, amides, ethers, esters, sulfones, aromatics, halogenated aliphatic hydrocarbons, and the like. Although a dip coating method may be used for applying the coating solution, a ring coating method, a roll coating method, a spray coating method, and the like may be also used.

Examples of the binder resin used in the photosensitive layer include, but are not limited to, polycarbonate, polyester, methacrylic resin, acrylic resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenolic resin, polyamide, carboxy-methyl cellulose, and polyurethane. These polymers may be used alone or in a combination of two or more.

In the electrohotographic photoreceptor of the present invention, any one of a hole transport material and an electron transport material may be used as the charge transport material.

Examples of the hole transport material used in the photosensitive layer include nitrogen containing cyclic compounds or condensed polycyclic compounds such as pyrene compounds, carbazole compounds, hydrazone compounds, oxazole compounds, oxadiazole compounds, pyrazoline compounds, arylamine compounds, arylmethane compounds, benzidine compounds, thiazole compounds, or styryl compounds.

Examples of the electron transport material include, but are not limited to, electron attracting low molecular weight compounds such as benzoquinone compounds, cyanoethylene compounds, cyanoquinodimethane compounds, fluorenone compounds, xanthone compounds, phenanthraquinone compounds, phthalic anhydride compounds, thiopyrane compounds, naphthalene compounds, diphenoquinone compounds, or stilbenequinone compounds.

The charge transport materials used in the electrophotographic photoreceptor are not limited to the materials listed herein, and may be used alone or in a combination of two or more.

In the case of a laminated type photoreceptor, the charge transport layer is formed by dispersing the charge transport material together with a binder resin in a solvent, and then applying the dispersion to the intermediate layer or to the charge generating layer. The thickness of the charge transport layer is typically set in a range of 5-50 μm. If the thickness is lower than 5 μm, the charging property is ineffective. If the thickness is greater than 50 μm, a response speed is reduced, and the image quality deteriorates.

The content of the charge transport material in the photosensitive layer may be in a range of 10-60% by weight based on a total weight of the photosensitive layer. If the content is less than 10% by weight, sensitivity is ineffective due to an insufficient charge transporting capability, thus resulting in higher residual potential. If the content is more than 60% by weight, the content of the resin in the photosensitive layer decreases, thus lowering mechanical strength.

In the case of a laminated photosensitive layer, although a charge transport layer 4 is generally formed on a charge generating layer 5, as shown in FIG. 3, the charge generating layer 5 may be also formed on the charge transport layer 4, as shown in FIG. 2.

In the case of a single-layered type photoreceptor, the photosensitive layer in which the charge transport material is dispersed together with a charge generating material, and a binder resin is used, and thus, a charge is generated in the photosensitive layer. Therefore, generally, the layer is capable of transporting both a hole and an electron, and the hole transport material and the electron transport material are used together as the charge transport material.

The thickness of the photosensitive layer may be set in the range of 5 to 50 μm regardless of whether the photosensitive layer is the laminated type or the single-layered type.

Also, the photosensitive layer may contain additives, such as a plasticizer, a leveling agent, a dispersion stabilizer, an antioxidant, a photo-stabilizing agent, and the like, in addition to the binder resin.

Examples of the antioxidant include phenolic compounds, sulfur compounds, phosphorous compounds, amine compounds.

Examples of the photo-stabilizer agent include benzotriazole compounds, benzophenone compounds, hindered amine compounds, and the like.

The electrophotographic photoreceptor may further include a surface protective layer, if desired.

The present invention will now be described in greater detail with reference to the following examples. The following examples are for illustrative purposes only, and are not intended to limit the scope of the invention. In Examples and Comparative Examples, “parts” means “parts by weight”.

### EXAMPLE 1

0.2 parts of polyvinylacetal resin (S-LEX BM-1, available from SEKISUI CHEMICAL) and 2 parts of titanium oxide powder (TT0-55 N, available from ISHIHARA INDUSTRY CO. LTD.) were added to 50 parts of a 8 wt % solution (solvent; methanol: 1-butanol=3:2) of alcohol soluble polyamide resin (AMILAN CM-8000, available from TORAY), and the mixture was sand-milled for approximately 1 hour to obtain a dispersion. 0.3 parts of acetylacetonate zirconium chelate (ORGATICS ZC-150, available from MATSUMOTO CHEMICAL INDUSTRY CO. LTD.) was further added in the obtained dispersion and uniformly mixed using a homogenizer to prepare a coating solution. The coating solution was applied to a drum made of polyamide containing electroconductive carbon with a diameter of 30 mm through a ring coating method, and then, dried at 140° C. for approximately 10 minutes to form an intermediate layer with a thickness of 4 μm.

3 parts of α-titanylphthalocyanine and 2 parts of polycarbonate Z resin (IUPILON Z-200, available from MITSUBISHI GAS CHEMICAL) were mixed with 45 parts of chloroform and finely pulverized using a sand mill for approximately 1 hour, and then dispersed.

15 parts of an electron transport material represented by Formula (1), 30 parts of a hole transport material represented by Formula (2), and 55 parts of the polycarbonate Z resin were dissolved in 300 parts of chloroform.

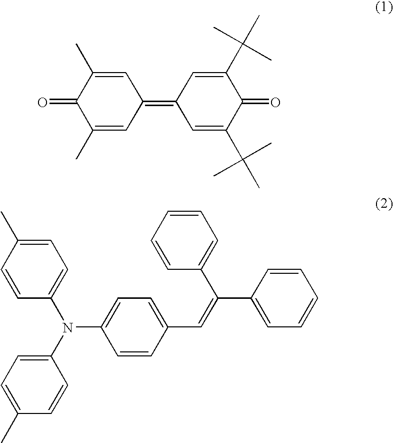

The dispersion and the solution were mixed in a ratio of 1:8 and uniformly stirred using a homogenizer to obtain a photosensitive layer coating solution. Then, the coating solution was applied to the intermediate layer through a ring coating method, and dried at 100° C. for approximately 1 hour to form a single-layered type photosensitive layer with a thickness of 20 μm, thus obtaining a electrophotographic photoreceptor.

### COMPARATIVE EXAMPLE 1

A photoreceptor was prepared by forming an intermediate layer in the same manner as in Example 1, except that the chelate compound was not added.

### COMPARATIVE EXAMPLE 2

A photoreceptor was prepared by forming an intermediate layer in the same manner as in Example 1, except that 0.4 parts of tetraisopropyl titanate (TYZOR TPT, available from DUPONT) was used instead of the chelate compound.

### EXAMPLE 2

A coating solution formed by adding 2 parts of acetylacetonate titanium chelate (TYZOR AA-75, available from DUPONT) to 50 parts of a 8 wt % solution (solvent; methanol: 1-butanol=3:2) of polyamide resin (AMILAN CM-8000, available from TORAY) and then by uniformly mixing the mixture with a homogenizer was applied to the same resinous drum as used in Example 1 through a ring coating method, and then dried at approximately 140° C. for approximately 10 minutes to form an intermediate layer with a thickness of 3 μm.

Thereafter, a coating solution obtained by dispersing 7 parts of α-titanylphthalocyanine and 6 parts of polyvinylbutyral resin (S-LEC BH-3, available from SEKISUI CHEMICAL) in 187 parts of methylene chloride using a sand mill was applied to the intermediate layer through a ring coating method and then dried to form a charge generating layer with a thickness of 0.4 μm.

A solution formed by dissolving 60 parts of polycarbonate resin (PANLITE C-1400, available from TEIJIN LTD.) and 40 parts of the hole transport material represented by Formula (2) above in 300 parts of chloroform was applied to the charge generating layer and dried at approximately 100° C. for approximately 1 hour to form a charge transport layer with a thickness of 20 μm, thus forming a laminated type photosensitive layer. As a result, an electrophotographic photoreceptor was obtained.

### COMPARATIVE EXAMPLE 3

An electrophotographic photoreceptor was prepared by forming an intermediate layer in the same manner as in Example 2, except that the chelate compound was not added.

Storage Stability

The respective coating solutions for an intermediate layer prepared in Examples and Comparative Examples were added to, and sealed in, a vial and left at room temperature. The state of the coating solutions after standing was observed. As a result, coating solutions of Examples 1 and 2 and Comparative Examples 1 and 3 were still stable after standing. The coating solution of Comparative Example 2 using tetraalkyl titanate as a crosslinker instead of the chelate compound became a gel.

Adhesiveness

Adhesiveness of the respective photoreceptor was evaluated by performing crosscut test according to a method prescribed in JIS-K5400.

The test was performed by incising the photosensitive layer with a cutter knife to form 100 cut-out boxes with a 1 mm×1 mm size and an adhesive tape was uniformly attached to the incised photosensitive layer, and then released. Then, the number of cut-out boxes remained on the substrate was counted and the results were shown Table 1 below.

TABLE 1

| | | | Compar- | | |
|---|---|---|---|---|---|
| Photo- | | | ative | Comparative | Comparative |
| receptor | Example 1 | Example 2 | Example 1 | Example 2 | Example 3 |
| Result | 100/100 | 100/100 | 18/100 | 100/100 | 23/100 |

Electrostatic Properties

Electrophotographic characteristics of the respective photoreceptor were evaluated using a photoreceptor evaluation apparatus (PDT-2000 manufactured by QEA) at 23 μm and 50% (N/N) humidity, and at 35° C. and 90% (H/H) humidity.

In the case of single layer type photoreceptors of Example 1 and Comparative Examples 1 and 2, a corona voltage +7.5 kV was applied for charging. In the case of dual layer type photoreceptors of Example 2 and Comparative Example 3, a corona voltage −7.5 kV was applied for charging. In both cases, charging was performed with a relative speed of a charger and a photoreceptor being 100 mm/sec, immediately followed by irradiating monochrome light having a wavelength of 780 nm at an exposure energy in the range between 0 and 10 mJ/m2. Then, surface potential values after exposure were recorded and compared with the exposure energy to investigate the relationship between the exposure energy and surface potential. Here, V₀(V) is a surface potential without light irradiation. Vᵢ(V) is a surface potential after exposure with light irradiation of 10 mJ/m². Energy required for V₀ decaying to a half value by irradiation is denoted by E1/2(mJ/m²). The measurement results are shown in Table 2.

TABLE 2

| Photoreceptor | Environment | V₀ (V) | Vᵢ (V) | E_{1/2} (mJ/m²) |
|---|---|---|---|---|
| Example 1 | N/N | 721 | 76 | 3.84 |
| | H/H | 693 | 66 | 3.63 |
| Comparative | N/N | 715 | 74 | 3.85 |
| Example 1 | | | | |
| | H/H | 596 | 64 | 4.18 |
| Comparative | N/N | 728 | 79 | 3.87 |
| Example 2 | | | | |
| | H/H | 703 | 68 | 3.66 |
| Example 2 | N/N | −843 | −65 | 3.46 |
| | H/H | −818 | −52 | 3.34 |
| Comparative | N/N | −832 | −88 | 3.57 |
| Example 3 | | | | |
| | H/H | −573 | −75 | 4.08 |

As is apparent from Table 1, photoreceptors of Examples 1 and 2 according to the present invention showed equivalent result to Comparative Example 2 using a crosslinker in terms of coating strength, and photoreceptors of Comparative Examples 1 and 3 without a chelate compound had very ineffective adhesiveness. As is apparent from Table 2, photoreceptors of Examples 1 and 2 according to the present invention retained effective electrostatic properties even at elevated temperature and humidity. This effect was similar to the photoreceptor of Comparative Example 2 using a general crosslinker. Meanwhile, the photoreceptors of Comparative Examples 1 and 3 had very reduced charging property at the above-described environment.

As described above, the photoreceptor according to the present invention has effective productivity as well as effective electrical and mechanical properties.

Although a few embodiments of the present invention have been shown and described, it would be appreciated by those skilled in the art that changes may be made in these embodiments without departing from the principles and spirit of the invention, the scope of which is defined in the claims and their equivalents.

1. An electrophotographic photoreceptor comprising:
an electrically conductive substrate including a resin;
an intermediate layer formed on the electrically conductive substrate; and
a photosensitive layer formed on the intermediate layer,
wherein the intermediate layer includes an alcohol soluble polyamide and an alcohol soluble chelate compound.

2. The electrophotographic photoreceptor of claim 1, wherein the chelate compound includes a titanium atom or a zirconium atom as a core metal.

3. The electrophotographic photoreceptor of claim 1, wherein the intermediate layer further includes a polyvinylacetal resin.

4. The electrophotographic photoreceptor of claim 1, wherein a content of the alcohol soluble chelate compound in the intermediate layer is 1-100 parts by weight based on 100 parts by weight of the alcohol soluble polyamide.

5. The electrophotographic photoreceptor of claim 1, wherein the alcohol soluble chelate compound is at least one selected from the group consisting of acetylacetonate chelate, acetoacetate chelate, lactate chelate, and glycolate chelate.

6. The electrophotographic photoreceptor of claim 1, wherein the intermediate layer further includes at least one additive selected from the group consisting of a charge transport material, an organic filler, and an inorganic filler.

7. The electrophotographic photoreceptor of claim 1, wherein the resin of the electrically conductive substrate is selected from the group consisting of polyester, polycarbonate, polyamide, polyimide, and any copolymer of monomers composing the foregoing polymers.

8. An electrophotographic imaging apparatus comprising an electrophotographic photoreceptor, the electrophotographic photoreceptor comprising:
an electrically conductive substrate including a resin;
an intermediate layer formed on the electrically conductive substrate; and
a photosensitive layer formed on the intermediate layer,
wherein the intermediate layer includes an alcohol soluble polyamide and an alcohol soluble chelate compound.

9. The electrophotographic imaging apparatus of claim 8, wherein the chelate compound includes a titanium atom or a zirconium atom as a core metal.

10. The electrophotographic imaging apparatus of claim 8, wherein the intermediate layer further includes a polyvinylacetal resin.

11. The electrophotographic imaging apparatus of claim 8, wherein a content of the alcohol soluble chelate compound in the intermediate layer is 1-100 parts by weight based on 100 parts by weight of the alcohol soluble polyamide.

12. The electrophotographic imaging apparatus of claim 8, wherein the alcohol soluble chelate compound is at least one selected from the group consisting of acetylacetonate chelate, acetoacetate chelate, lactate chelate, and glycolate chelate.

13. The electrophotographic imaging apparatus of claim 8, wherein the intermediate layer further includes at least one additive selected from the group consisting of a charge transport material, an organic filler, and an inorganic filler.

14. The electrophotographic imaging apparatus of claim 8, wherein the resin of the electrically conductive substrate is selected from the group consisting of polyester, polycarbonate, polyamide, polyimide, and any copolymer of monomers composing the foregoing polymers.

15. An electrophotographic cartridge comprising:
an electrophotographic photoreceptor comprising an electrically conductive substrate including a resin, an intermediate layer formed on the electrically conductive substrate, and a photosensitive layer formed on the intermediate layer, the intermediate layer including an alcohol soluble polyamide and an alcohol soluble chelate compound; and
at least one of:
a charging device charging the electrophotographic photoreceptor;
a developing device developing an electrostatic latent image formed on the electrophotographic photoreceptor; and
a cleaning device cleaning a surface of the electrophotographic photoreceptor,
wherein the electrophotographic cartridge is attachable to or detachable from an image forming apparatus.

16. An electrophotographic drum comprising:
a drum that is attachable to or detachable from an image forming apparatus; and
an electrophotographic photoreceptor disposed on the drum, the electrophotographic photoreceptor comprising an electrically conductive substrate including a resin, an intermediate layer formed on the electrically conductive substrate, and a photosensitive layer formed on the intermediate layer, the intermediate layer including an alcohol soluble polyamide and an alcohol soluble chelate compound.

17. An image forming apparatus comprising:
a photoreceptor unit comprising:
an electrically conductive substrate including a resin;
an intermediate layer formed on the electrically conductive substrate; and
a photosensitive layer formed on the intermediate layer, the intermediate layer including an alcohol soluble polyamide and an alcohol soluble chelate compound;
a charging device charging the photoreceptor unit;
an imagewise light irradiating device irradiating imagewise light onto the charged photoreceptor unit to form an electrostatic latent image on the photoreceptor unit;
a developing unit developing the electrostatic latent image with a toner to form a toner image on the photoreceptor unit; and
a transfer device transferring the toner image onto a receiving medium.

18. The electrophotographic photoreceptor of claim 1, wherein the photosensitive layer is a laminated-type photosensitive layer, sequentially including a charge transport layer comprising a charge transport material and a charge generating layer comprising a charge generating material.

19. The electrophotographic photoreceptor of claim 1, wherein the photosensitive layer is a laminated-type photosensitive layer, sequentially including a charge generating layer comprising a charge generating material and a charge transport layer comprising a charge transport material.

20. The electrophotographic imaging apparatus of claim 8, wherein the photosensitive layer is a laminated-type photosensitive layer, sequentially including a charge transport layer comprising a charge transport material and a charge generating layer comprising a charge generating material.

21. The electrophotographic imaging apparatus of claim 8, wherein the photosensitive layer is a laminated-type photosensitive layer, sequentially including a charge generating layer comprising a charge generating material and a charge transport layer comprising a charge transport material.

22. The electrophotographic photoreceptor of claim 1, wherein the photosensitive layer is a single-type photosensitive layer comprising a charge transport material and a charge generating material.

23. The electrophotographic imaging apparatus of claim 8, wherein the photosensitive layer is a single-type photosensitive layer comprising a charge transport material and a charge generating material.
